(19) United States
(12) Patent Application Publication
(10) Pub. No.: US 2024/0179155 A1
(43) Pub. Date: May 30, 2024

(54) METHOD AND SYSTEM FOR NETWORK SECURITY SITUATION ASSESSMENT

(71) Applicant: AJOU UNIVERSITY INDUSTRY-ACADEMIC COOPERATION FOUNDATION, Suwon-si (KR)

(72) Inventors: Jin KWAK, Suwon-si (KR); Deuk Hun KIM, Suwon-si (KR); Lelisa Adeba JILCA, Suwon-si (KR)

(73) Assignee: AJOU UNIVERSITY INDUSTRY-ACADEMIC COOPERATION FOUNDATION, Suwon-si (KR)

(21) Appl. No.: 18/397,144

(22) Filed: Dec. 27, 2023

(30) Foreign Application Priority Data
Dec. 29, 2022 (KR) 10-2022-0188890

(51) Int. Cl. H04L 9/40

(52) U.S. Cl. CPC H04L 63/1416

(57) ABSTRACT

A network security situation assessment method of a network system includes: obtaining network traffic of the network system; detecting an attack on the network system from the obtained network traffic; identifying the detected attack; analyzing a possibility of an attack and an impact of an attack on the network system based on results of the detecting and identifying of the attack; and assessing a network situation of the network system based on a result of the analyzing, wherein the detecting of the attack on the network system includes detecting the attack from the network traffic using deep learning-based first model and second model.

### CROSS-REFERENCE TO RELATED APPLICATION

This application claims the benefit of Korean Patent Application No. 10-2022-0188890, filed on Dec. 29, 2022, in the Korean Intellectual Property Office, the disclosure of which is incorporated herein in its entirety by reference.

### BACKGROUND

### 1. Field

The disclosure relates to a method and system for network security situation assessment.

### 2. Description of the Related Art

Situational awareness is the concept of understanding what we are seeing to better understand an underlying environment and respond effectively to events. On the other hand, situation assessment corresponds to a core task of situation awareness, which analyzes all kinds of events and provides insightful information about an underlying environment to enable correct decisions and actions.

In the context of computer networks, network security situation assessment (NSSA) is a widely used approach to passively and actively assess all states of a network. This may enhance activities and technologies used to respond to network attacks, such as intrusion detection or intrusion prevention systems (IDS/IPS), and security orchestration automation and response (SOAR).

However, the conventional NSSA method faces difficulties in effectively identifying various network attacks that are increasing day by day, which may lead to a decrease in the security of a network system.

### SUMMARY

Provided is a method of accurately assessing network situations through effective identification of various network attacks.

According to an aspect of an embodiment, a network security situation assessment method of a network system comprising: obtaining network traffic of the network system; detecting an attack on the network system from the obtained network traffic; identifying the detected attack; analyzing a possibility of an attack and an impact of an attack on the network system based on results of the detecting and identifying of the attack; and assessing a network situation of the network system based on a result of the analyzing, and the detecting of the attack on the network system comprises detecting the attack from the network traffic using deep learning-based first model and second model.

According to an exemplary embodiment, the first model comprises a convolutional autoencoder (CAE), and the detecting of the attack comprises: inputting the network traffic into the first model; obtaining a reconstruction error between reconstructed network traffic output from the first model and the input network traffic; and detecting the attack based on the obtained reconstruction error.

According to an exemplary embodiment, the second model comprises a long-short term memory (LSTM), and the detecting of the attack comprises: obtaining a dimensionally reduced vector based on the input network traffic from the first model; inputting the obtained dimensionally reduced vector into the second model; obtaining a prediction error between a prediction result of a network traffic pattern output from the second model and network traffic occurring in the network system; and detecting the attack based on the obtained reconstruction error and prediction error.

According to an exemplary embodiment, the detecting of the attack based on the obtained reconstruction error and prediction error comprises: detecting that the network traffic includes an attack when a weighted average of the reconstruction error and the prediction error exceeds a predefined threshold.

According to an exemplary embodiment, the CAE is trained to generate dimensionally reduced vectors from normal network traffic and to generate reconstructed network traffic based on the dimensionally reduced vectors, and the LSTM is trained to sequentially receive the dimensionally reduced vectors of the normal network traffic and to predict a network traffic pattern based on the received vectors.

According to an exemplary embodiment, the identifying of the detected attack comprises identifying the detected attack using a model generated based on deep learning to identify the attack from network traffic in which the attack is detected.

According to an exemplary embodiment, the analyzing of the possibility of the attack and the impact of the attack on the network system comprises: analyzing the possibility of the attack on the network system based on a security vulnerability analysis result of the network system and a result of the detecting of the attack; and analyzing the impact of the attack on the network system based on the security vulnerability analysis result and a result of the identifying of the attack, and the security vulnerability analysis result is provided based on common vulnerability and exposure (CVE).

According to an exemplary embodiment, the assessing of the network situation comprises assessing the network situation indicating a security risk of the network system based on a result of the analyzing of the possibility of the attack and the impact of the attack.

According to an aspect of an embodiment, a network security situation assessment system of a network system comprising: a situation extraction unit configured to detect and identify an attack from network traffic of the network system; a situation analysis unit configured to analyze a possibility of an attack and an impact of an attack on the network system based on results of the detecting and identifying of the attack; and a situation assessment unit configured to assess a network situation of the network system based on a result of the analyzing, wherein the situation extraction unit comprises an attack detection unit configured to detect an attack from the network traffic, and the attack detection unit comprises a first model and a second model based on deep learning.

### BRIEF DESCRIPTION OF THE DRAWINGS

Embodiments of the disclosure will be more clearly understood from the following detailed description taken in conjunction with the accompanying drawings in which:

FIG. 1 is a schematic view of a network system including a security situation assessment system, according to an embodiment;

FIG. 2 is a view of a schematic configuration of a security situation assessment system, according to an embodiment;

FIG. 3 is a view of a schematic configuration of a situation extraction unit shown in FIG. 2;

FIG. 4 is an exemplary view of a first model and a second model shown in FIG. 3;

FIG. 5 is a view of a schematic configuration of a situation analysis unit and a situation assessment unit shown in FIG. 2;

FIG. 6 is a flowchart to explain a security situation assessment method of a network, according to an embodiment; and

FIG. 7 is a schematic block diagram of a device performing a security situation assessment method, according to an embodiment.

### DETAILED DESCRIPTION

Embodiments according to the inventive concept are provided to more completely explain the inventive concept to one of ordinary skill in the art, and the following embodiments may be modified in various other forms and the scope of the inventive concept is not limited to the following embodiments. Rather, these embodiments are provided so that the disclosure will be thorough and complete, and will fully convey the scope of the disclosure to one of ordinary skill in the art.

It will be understood that, although the terms first, second, etc. may be used herein to describe various members, regions, layers, sections, and/or components, these members, regions, layers, sections, and/or components should not be limited by these terms. These terms do not denote any order, quantity, or importance, but rather are only used to distinguish one component, region, layer, and/or section from another component, region, layer, and/or section. Thus, a first member, component, region, layer, or section discussed below could be termed a second member, component, region, layer, or section without departing from the teachings of embodiments. For example, as long as within the scope of this disclosure, a first component may be named as a second component, and a second component may be named as a first component.

Unless otherwise defined, all terms (including technical and scientific terms) used herein have the same meaning as commonly understood by one of ordinary skill in the art to which the disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a certain embodiment may be implemented differently, a specific process order may be performed differently from the described order. For example, two consecutively described processes may be performed substantially at the same time or performed in an order opposite to the described order.

In the drawings, variations from the illustrated shapes may be expected because of, for example, manufacturing techniques and/or tolerances. Thus, embodiments of the inventive concept should not be construed as being limited to the particular shapes of regions illustrated herein but may include deviations in shapes that result, for example, from manufacturing processes. Like reference numerals in the drawings denote like elements, and thus their overlapped explanations are omitted.

As used herein, the term “and/or” includes any and all combinations of one or more of the associated listed items.

Hereinafter, embodiments of the inventive concept will be described in detail with reference to the accompanying drawings.

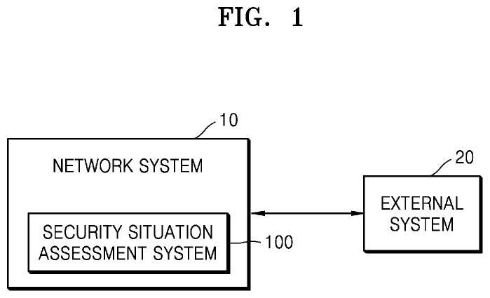

FIG. 1 is a schematic view of a network system including a security situation assessment system, according to an embodiment.

Referring to FIG. 1, each of a network system 10 and an external system 20 consists of various fixed/mobile terminals such as at least one of personal computer (PC), laptop, smartphone, tablet PC, and IoT device, or various communication devices such as a server, base station, and repeater, and may include various networks such as an internal network, a smart factory, and an Internet of Things network.

At this time, an external attacker, etc. may attempt an attack (cyber attack) on the network system 10 through the external system 20 or a device connected to the external system 20. For example, the above attack includes malware, phishing, ransomware, distributed denial of service (DDoS), and cryptojacking, and detailed attack patterns for each type are becoming increasingly diverse.

The network system 10 may include a security situation assessment system 100 that assesses a security situation through analysis of network traffic according to data transmission and reception. The security situation assessment system 100 according to an embodiment may detect abnormal network traffic by analyzing spatial and temporal characteristics of network traffic, and identify a cyber attack or assess a security status of a network based on a result of the detecting. Hereinafter, specific security situation assessment operations of the security situation assessment system 100 will be described with reference to the drawings.

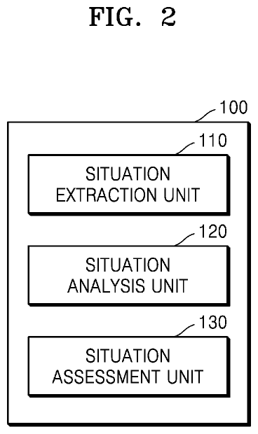

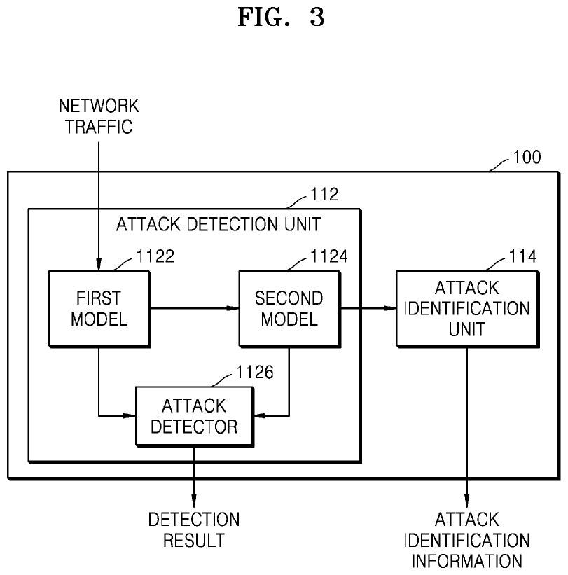

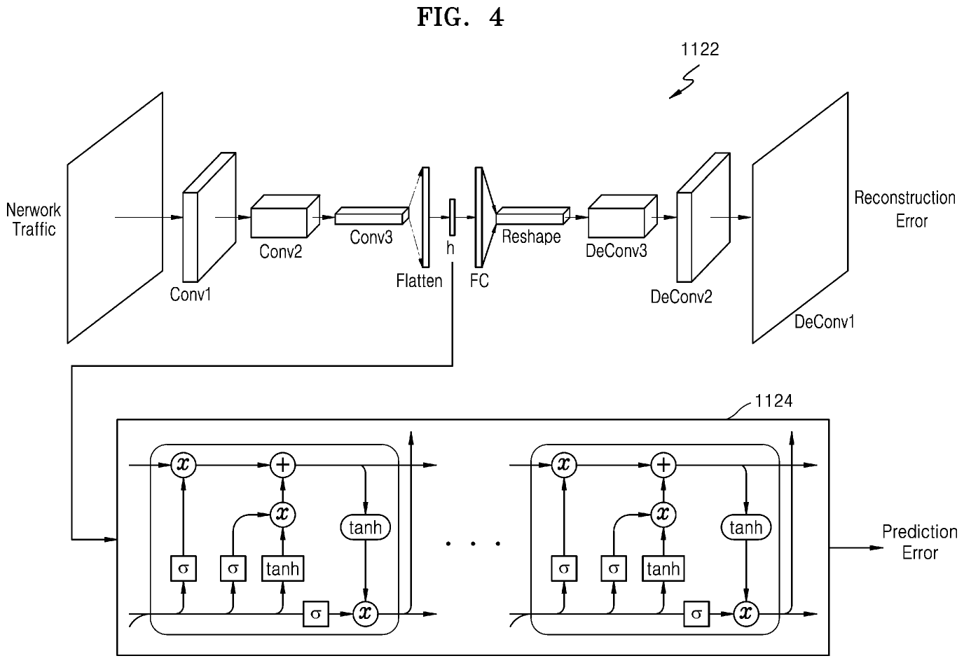

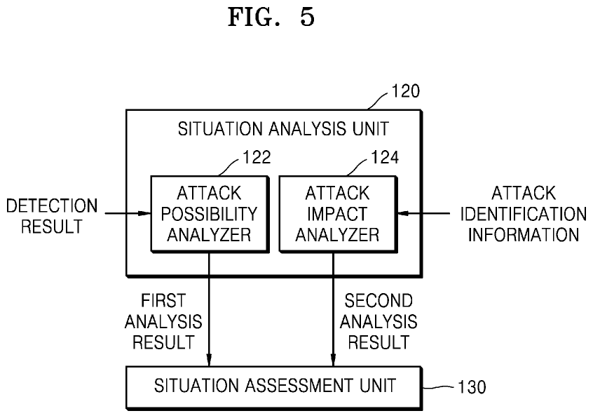

FIG. 2 is a view of a schematic configuration of a security situation assessment system, according to an embodiment. FIG. 3 is a view of a schematic configuration of a situation extraction unit shown in FIG. 2. FIG. 4 is an exemplary view of a first model and a second model shown in FIG. 3. FIG. 5 is a view of a schematic configuration of a situation analysis unit and a situation assessment unit shown in FIG. 2.

Referring to FIG. 2, the security situation assessment system 100 may include a situation extraction unit 110, a situation analysis unit 120, and a situation assessment unit 130. The security situation assessment system 100 may be implemented with at least one computing device, in which case the situation extraction unit 110, the situation analysis unit 120, and the situation assessment unit 130 may be implemented integrated or separately in the at least one computing device.

The situation extraction unit 110 may detect and identify abnormal network traffic (a cyber attack) through analysis of network traffic occurring on the network system 10.

The situation extraction unit 110 according to an embodiment may detect and identify an attack on the network system 10 by analyzing network traffic of the network system 10 based on a deep learning-based model that models spatial and temporal characteristics of normal network traffic.

Referring to FIGS. 3 and 4 together, the situation extraction unit 110 may include an attack detection unit 112 and an attack identification unit 114. The attack detection unit 112 may detect the presence or absence of an attack from network traffic, and the attack identification unit 114 may identify the attack detected by the attack detection unit 112.

The attack detection unit 112 may include a first model 1122, a second model 1124, and an attack detector 1126. Each of the first model 1122 and the second model 1124 may be implemented as a deep learning-based model (artificial neural network, etc.). For example, the first model 1122 is implemented as a convolutional autoencoder (CAE) model, modeling spatial characteristics of network traffic and performing dimensionality reduction on multi-dimensional network traffic. The second model 1124 is implemented as a long-short term memory (LSTM) model and may model temporal characteristics of network traffic.

An autoencoder is an unsupervised learning model (or self-supervised learning model) that learns patterns of input data and reconstructs data as similar as possible. The autoencoder may include an encoder that converts input data into a low-dimensional vector, and a decoder that extracts features from the converted vector and generates and outputs data as similar as possible to the input data. The Autoencoder may be mainly used to reduce dimensionality of data, remove noise, detect abnormalities, and make recommendations.

The autoencoder requires input data to be provided in the form of a single-dimensional vector, but network traffic of the network system 10 may correspond to a multi-dimensional vector with spatial characteristics. Therefore, the first model 1122 according to an embodiment is implemented as a CAE model capable of inputting multi-dimensional vectors, and may be trained to reduce the dimensionality of input normal network traffic and reconstruct the network traffic.

The attack detection unit 112 may generate a dimensionally reduced vector from input network traffic using the trained first model 1122 and generate reconstructed network traffic based on the dimensionally reduced vector. The attack detection unit 112 may obtain a reconstruction error based on a difference between the reconstructed network traffic and the input network traffic. The reconstruction error may increase as the input network traffic corresponds to abnormal network traffic.

LSTM is a variation of RNN suitable for time series data. The second model 1124, implemented as LSTM, may be trained to predict network traffic patterns based on normal network traffic. In more detail, the second model 1124 may sequentially receive dimensionally reduced vectors of the normal network traffic provided from the first model 1122 and be trained to predict a pattern of network traffic based on the received vectors.

The second model 1124 of the attack detection unit 112 may predict a network traffic pattern based on the dimensionally reduced vector provided sequentially from the first model 1122 over time. The attack detection unit 112 may obtain a prediction error based on a difference between the network traffic pattern predicted by the second model 1124 and network traffic obtained from the network system 10. The prediction error may also increase as the network traffic corresponds to abnormal network traffic.

The attack detector 1126 may detect an attack from input network traffic based on a reconstruction error output from the first model 1122 and a prediction error output from the second model 1124. For example, when a weighted average of the reconstruction error and prediction error exceeds a threshold, the attack detector 1126 may output a result of detecting whether network traffic includes an attack.

When the attack detection unit 112 detects an attack from network traffic, the attack identification unit 114 may output attack identification information identifying name/type/form, etc. of the detected attack. For example, the attack identification unit 114 may be implemented as a fully connected deep neural network (FC-DNN) trained to identify an attack included in network traffic.

FIG. 2 will be described again.

The situation analysis unit 120 included in the security situation assessment system 100 may analyze a possibility of a network attack on the network system 10 and an effect (impact) of an attack based on an attack detection result and attack identification information of the situation extraction unit 110. The situation assessment unit 130 may assess a security situation of a network by determining the severity of a network situation based on a result of the analysis of the situation analysis unit 120.

Referring to FIG. 5 together, the situation analysis unit 120 may include an attack possibility analyzer 122 and an attack impact analyzer 124.

The attack possibility analyzer 122 may provide a first analysis result of analyzing a possibility of an attack on the network system 10 based on the attack detection result of the attack detection unit 112 to the situation assessment unit 130. The attack impact analyzer 124 may provide a second analysis result that analyzes the extent to which the network system 10 is affected by an identified attack (attack impact) based on the attack identification information of the attack identification unit 114 to the situation assessment unit 130.

For example, the attack possibility analyzer 122 and the attack impact analyzer 124 may generate a first analysis result and a second analysis result, respectively, based on a security vulnerability analysis result of the network system 10 based on common vulnerability and exposure (CVE), a security vulnerability management system of MIT research and engineering (MITRE), the attack detection result, and the attack identification information. The first analysis result may express the degree of attack possibility as a value (the higher the attack possibility, the greater the value), and the second analysis result may express the degree of attack impact as a value (the greater the attack impact, the greater the value).

The situation assessment unit 130 may assess a network situation of the network system 10 by integrating the first and second analysis results provided from the situation analysis unit 120. For example, the network situation may indicate a security risk of the network system 10.

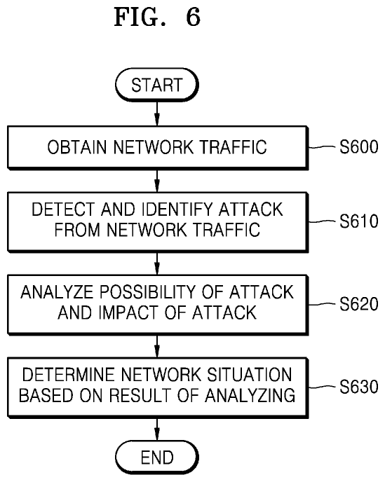

FIG. 6 is a flowchart to explain a security situation assessment method of a network, according to an embodiment.

Referring to FIG. 6, the security situation assessment system 100 may obtain (or monitor) network traffic of the network system 10 in operation S600, and may detect and identify an attack (a cyber attack) from the network traffic in operation S610.

In operation S620, the security situation assessment system 100 may analyze a possibility of an attack and an impact of an attack on the network system 10 based on a result of the detecting and identifying of the attack.

In operation S630, the security situation assessment system 100 may determine (assess) a network situation of the network system 10 based on a result of the analyzing of the possibility of the attack and the impact of the attack.

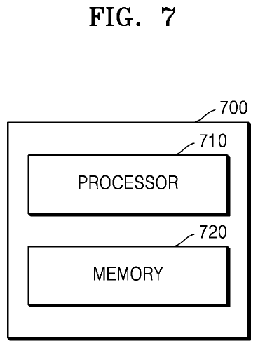

FIG. 7 is a schematic block diagram of a device performing a security situation assessment method, according to an embodiment.

Referring to FIG. 7, a device 700 according to an embodiment may correspond to any one of at least one computing device constituting the security situation assessment system 100 described above with reference to FIG. 2. In this case, the device 700 may correspond to a device that performs an operation to detect and identify an attack, an operation to analyze a possibility of an attack and an impact of an attack, and an operation to assess a network situation of the network system 10 based on a result of the analyzing of the possibility of the attack and the impact of the attack, described above in this specification.

The device 700 may include a processor 710 and a memory 720. However, components of the device 700 are not limited to the examples described above. For example, the device 700 may include more or fewer components than the components described above. In addition, there may be at least one processor 710 and there may be at least one memory 720. In addition, two or more of the processor 710 and the memory 720 may be combined into one chip.

According to an embodiment, the processor 710 may correspond to at least one of the situation extraction unit 110, the situation analysis unit 120, and the situation assessment unit 130 described above, or may execute or control at least one of the above components.

The processor 710 may include hardware such as a central processing unit (CPU), an application processor (AP), an integrated circuit, a microcomputer, an application specific integrated circuit (ASIC), a field programmable gate array (FPGA), and/or a neural processing unit (NPU).

According to an embodiment, the memory 720 may store programs and data necessary for the operations of the device 700.

In addition, the memory 720 may store at least one of data generated or obtained through the processor 710. According to an embodiment, the memory 720 may store data, instructions, algorithms, etc. related to the situation extraction unit 110, the situation analysis unit 120, and/or the situation assessment unit 130. In addition, the memory 720 may be understood as a concept that includes a database.

The memory 720 may be composed of a storage medium such as ROM, RAM, flash memory, SSD, or HDD, or a combination of storage media.

According to the inventive concept, by modeling spatial and temporal characteristics of network traffic through a combination of a convolutional autoencoder (CAE) and a long-short term memory (LSTM), network situations may be accurately assessed through accurate identification of various network attacks.

Effects obtainable by the inventive concept are not limited to the effects described above, and other effects not described herein may be clearly understood by one of ordinary skill in the art to which the disclosure belongs from the above description.

While the disclosure has been particularly shown and described with reference to embodiments thereof, it will be understood that various changes in form and details may be made therein without departing from the spirit and scope of the following claims.

In addition, it will be apparent to one of ordinary skill in the art that various changes and modifications are possible within a range that does not deviate from the basic principles of the disclosure.

What is claimed is:

1. A network security situation assessment method of a network system, the network security situation assessment method comprising:
obtaining network traffic of the network system;
detecting an attack on the network system from the obtained network traffic;
identifying the detected attack;
analyzing a possibility of an attack and an impact of an attack on the network system based on results of the detecting and identifying of the attack; and
assessing a network situation of the network system based on a result of the analyzing,
wherein the detecting of the attack on the network system comprises:
detecting the attack from the network traffic using deep learning-based first model and second model.

2. The network security situation assessment method of claim 1, wherein the first model comprises a convolutional autoencoder (CAE), and
the detecting of the attack comprises:
inputting the network traffic into the first model;
obtaining a reconstruction error between reconstructed network traffic output from the first model and the input network traffic; and
detecting the attack based on the obtained reconstruction error.

3. The network security situation assessment method of claim 2, wherein the second model comprises a long-short term memory (LSTM), and
the detecting of the attack comprises:
obtaining a dimensionally reduced vector based on the input network traffic from the first model;
inputting the obtained dimensionally reduced vector into the second model;
obtaining a prediction error between a prediction result of a network traffic pattern output from the second model and network traffic occurring in the network system; and
detecting the attack based on the obtained reconstruction error and prediction error.

4. The network security situation assessment method of claim 3, wherein the detecting of the attack based on the obtained reconstruction error and prediction error comprises:
detecting that the network traffic includes an attack when a weighted average of the reconstruction error and the prediction error exceeds a predefined threshold.

5. The network security situation assessment method of claim 3, wherein the CAE is trained to generate dimensionally reduced vectors from normal network traffic and to generate reconstructed network traffic based on the dimensionally reduced vectors, and
the LSTM is trained to sequentially receive the dimensionally reduced vectors of the normal network traffic and to predict a network traffic pattern based on the received vectors.

6. The network security situation assessment method of claim 1, wherein the identifying of the detected attack comprises:
identifying the detected attack using a model generated based on deep learning to identify the attack from network traffic in which the attack is detected.

7. The network security situation assessment method of claim 1, wherein the analyzing of the possibility of the attack and the impact of the attack on the network system comprises:
analyzing the possibility of the attack on the network system based on a security vulnerability analysis result of the network system and a result of the detecting of the attack; and
analyzing the impact of the attack on the network system based on the security vulnerability analysis result and a result of the identifying of the attack, wherein
the security vulnerability analysis result is provided based on common vulnerability and exposure (CVE).

8. The network security situation assessment method of claim 1, wherein the assessing of the network situation comprises:
assessing the network situation indicating a security risk of the network system based on a result of the analyzing of the possibility of the attack and the impact of the attack.

9. A network security situation assessment system of a network system, the network security situation assessment system comprising:
a situation extraction unit configured to detect and identify an attack from network traffic of the network system;
a situation analysis unit configured to analyze a possibility of an attack and an impact of an attack on the network system based on results of the detecting and identifying of the attack; and
a situation assessment unit configured to assess a network situation of the network system based on a result of the analyzing,
wherein the situation extraction unit comprises an attack detection unit configured to detect an attack from the network traffic, and
the attack detection unit comprises a first model and a second model based on deep learning.

10. The network security situation assessment system of claim 9, wherein the first model comprises a convolutional autoencoder (CAE), and
the attack detection unit is configured to:
input the network traffic into the first model,
obtain a reconstruction error between reconstructed network traffic output from the first model and the input network traffic, and
detect the attack based on the obtained reconstruction error.

11. The network security situation assessment system of claim 10, wherein the second model comprises a long-short term memory (LSTM), and
the attack detection unit is configured to:
obtain a dimensionally reduced vector based on the input network traffic from the first model,
input the obtained dimensionally reduced vector into the second model,
obtain a prediction error between a prediction result of a network traffic pattern output from the second model and network traffic occurring in the network system, and
detect the attack based on the obtained reconstruction error and prediction error.

12. The network security situation assessment system of claim 11, wherein the attack detection unit detects that the network traffic includes an attack when a weighted average of the reconstruction error and the prediction error exceeds a predefined threshold.

13. The network security situation assessment system of claim 11, wherein the CAE is trained to generate dimensionally reduced vectors from normal network traffic and to generate reconstructed network traffic based on the dimensionally reduced vectors, and
the LSTM is trained to sequentially receive the dimensionally reduced vectors of the normal network traffic and to predict a network traffic pattern based on the received vectors.

14. The network security situation assessment system of claim 9, wherein the situation extraction unit further comprises:
an attack identification unit configured to identify the detected attack,
wherein the attack identification unit comprises a model generated based on deep learning to identify the attack from network traffic in which the attack is detected.

15. The network security situation assessment system of claim 9, wherein the situation analysis unit is configured to:
analyze the possibility of the attack on the network system based on a security vulnerability analysis result of the network system and a result of the detecting of the attack, and
analyze the impact of the attack on the network system based on the security vulnerability analysis result and a result of the identifying of the attack,
wherein the security vulnerability analysis result is provided based on common vulnerability and exposure (CVE).

16. The network security situation assessment system of claim 9, wherein the situation assessment unit analyzes a security risk of the network system based on a result of the analyzing of the possibility of the attack and the impact of the attack.

17. The network security situation assessment system of claim 9, wherein the network security situation assessment system comprises at least one computing device.
